(19) United States
(12) Patent Application Publication
(10) Pub. No.: US 2026/0319519 A1
(43) Pub. Date: Oct. 15, 2026

(54) SWIMMING POOL CLEANING ROBOT CONTROL METHOD, SYSTEM, AND MEDIUM

(71) Applicant: Seauto (Guangdong Hengqin) Technology Co., Ltd., Zhuhai City (CN)

(72) Inventor: Hansheng Mo, Zhuhai City (CN)

(21) Appl. No.: 19/686,907

(22) Filed: May 25, 2026

Related U.S. Application Data
(63) Continuation of application No. PCT/CN2024/094505, filed on May 21, 2024.

(30) Foreign Application Priority Data
Apr. 25, 2024 (CN) 202410502834.6

(51) Int. Cl. G05D 1/661; E04H 4/16; G05D 1/648; G05D 105/10; G05D 107/00

(52) U.S. Cl. CPC G05D 1/661; E04H 4/1654; G05D 1/648; G05D 2105/10; G05D 2107/29

(57) ABSTRACT

A swimming pool cleaning robot control method, the swimming pool cleaning robot control method is applied to a swimming pool cleaning robot, the swimming pool cleaning robot is provided with a hydrophone configured to monitor a recall signal, the swimming pool cleaning robot control method includes the following steps: monitoring a recall signal in real-time by the hydrophone in response to the swimming pool cleaning robot executing a cleaning task; interrupting the cleaning task in response to the presence of the recall signal being monitored by the hydrophone, and executing a recall operation according to a preset edge-approach strategy, performing a forward movement toward a swimming pool wall. The present disclosure may enable the swimming pool cleaning robot to automatically approach the edge, improving work efficiency and user experience.

### CROSS REFERENCE TO RELATED APPLICATIONS

The present application is a Continuation Application of PCT Application No. PCT/CN2024/094505 filed on May 21, 2024, which claims priority of Chinese Patent Application No. 2024105028346 filed on Apr. 25, 2024, before CNIPA. All the above are hereby incorporated by reference in their entirety as part of the present disclosure.

### TECHNICAL FIELD

The present disclosure relates to the technical field of robots, and more particularly to a swimming pool cleaning robot control method, system, and medium.

### BACKGROUND

Swimming pool cleaning robots belong to consumer-grade robots, which are configured to clean swimming pools, with functions similar to those of floor-sweeping robots, and the difference from floor-sweeping robots is that the application scenario of swimming pool cleaning robots is underwater, requiring work in swimming pools, swimming pool cleaning has always had a pain point, namely, manual cleaning is tedious and time-consuming, and the industry commonly begins to use robots for swimming pool cleaning work.

Current swimming pool cleaning robots are mostly hooked out of the swimming pool by means of a hook in response to completion of a cleaning task or in response to a desire to interrupt the cleaning task. However, often, the hook-equipped pole used by people standing on the shore is sometimes not long enough in response to the robot performing a cleaning task, or after the pole is too long, it is difficult to exert force to hook it out. Only a small number of models may actively approach the edge in response to completion of a cleaning task, but in response to interruption of the task, still forcibly interrupt the execution of the robot's cleaning task by means of a hook.

### SUMMARY

A primary objective of the present disclosure is to propose a swimming pool cleaning robot control method, system, and medium, aimed at achieving automatic edge approach of the swimming pool cleaning robot, and improving work efficiency and user experience.

To achieve the above objective, the present disclosure provides a swimming pool cleaning robot control method, where the swimming pool cleaning robot control method is applied to a swimming pool cleaning robot, the swimming pool cleaning robot is provided with a hydrophone for monitoring a recall signal, the swimming pool cleaning robot control method including the following steps:
step S10, monitoring the recall signal in real-time through the hydrophone in response to the swimming pool cleaning robot performing a cleaning task;
step S20, interrupting the cleaning task in response to the presence of the recall signal being monitored by the hydrophone, and executing, according to a preset edge-approach strategy, a recall operation, advancing toward the swimming pool wall.

In some implementations, step S201 includes:
step S201, interrupting the cleaning task in response to the presence of the recall signal being monitored by the hydrophone, and determining, according to a signal strength of the recall signal, a direction of a signal source;
step S202, controlling the swimming pool cleaning robot to travel toward the direction of the signal source, docking at the swimming pool wall.

In some implementations, step S201 includes:
acquiring, using a multi-path effect and a fading principle, a direction with a strongest recall signal, interrupting the cleaning task, and acquiring, according to the direction with the strongest recall signal, the direction of the signal source.

In some implementations, where step S201 includes:
step S203, searching for the recall signal in place, in response to the recall signal being lost during the swimming pool cleaning robot traveling toward the direction of the signal source; returning to execute step S201 in response to the recall signal being re-monitored within a first preset duration;
executing step S204, executing the cleaning task, and no longer monitoring the recall signal within a second preset duration, in response to an absence of the recall signal being monitored within the first preset duration.

In some implementations, the method further includes:
step S101, continuing to execute the cleaning task in response to an absence of the recall signal being monitored by the hydrophone.

In some implementations, after step S202, the method includes:
controlling the swimming pool cleaning robot to climb the wall along the swimming pool wall and surface in response to the swimming pool cleaning robot arriving at the swimming pool wall.

In some implementations, step S201 includes:
controlling the swimming pool cleaning robot to advance according to a current movement direction until arriving at the swimming pool wall in response to the presence of the recall signal being monitored by the hydrophone.

To achieve the above purpose, the present disclosure also proposes a swimming pool cleaning robot control system, the swimming pool cleaning robot is provided with a hydrophone for monitoring a recall signal, the system includes a memory, a processor, and a swimming pool cleaning robot control program stored on the processor, the swimming pool cleaning robot control program, when invoked by the processor, executing the following steps:
monitoring the recall signal in real-time through the hydrophone in response to the swimming pool cleaning robot performing a cleaning task;
interrupting the cleaning task in response to the presence of the recall signal being monitored by the hydrophone, and advancing, according to the preset edge-approach strategy, toward the swimming pool wall.

In some implementations, the swimming pool cleaning robot control program, when invoked by the processor, further executing the following steps:
interrupting the cleaning task in response to the presence of the recall signal being monitored by the hydrophone, and determining, according to a signal strength of the recall signal, a direction of a signal source;
controlling the swimming pool cleaning robot to travel toward the direction of the signal source, docking at the swimming pool wall.

To achieve the above purpose, the present disclosure also proposes a non-transitory computer-readable storage medium, where the non-transitory computer-readable storage medium stores a swimming pool cleaning robot control program, the swimming pool cleaning robot control program executing the steps of the method as described above when invoked by the processor.

The beneficial effects of the swimming pool cleaning robot control method, system, and medium of the present disclosure are as follows:

The present disclosure, through the above technical solution, monitors the recall signal in real-time through the hydrophone; controlling the swimming pool cleaning robot to advance according to the current movement direction, executes the recall operation according to a preset edge-approach strategy, advancing toward the swimming pool wall, leading to enabling the swimming pool cleaning robot to automatically approach the edge, enhancing work efficiency and user experience.

### BRIEF DESCRIPTION OF THE DRAWINGS

To more clearly illustrate the technical solutions in the embodiments of the present disclosure or the prior art, a brief introduction to the accompanying drawings required for describing the embodiments or the prior art is provided below. Obviously, the accompanying drawings in the following description merely show some embodiments of the present disclosure. For a person of ordinary skill in the art, other accompanying drawings may be obtained based on the structures illustrated in these accompanying drawings without making creative efforts.

FIG. 1 is a schematic flowchart of a first embodiment of a swimming pool cleaning robot control method of the present disclosure;

FIG. 2 is a schematic flowchart of a second embodiment of the swimming pool cleaning robot control method of the present disclosure;

FIG. 3 is a schematic structural diagram of a signal multi-path fading effect;

FIG. 4 is a schematic flowchart of a third embodiment of the swimming pool cleaning robot control method of the present disclosure;

FIG. 5 is a schematic flowchart of a fourth embodiment of the swimming pool cleaning robot control method of the present disclosure.

The realization of the objectives, the functional features, and the advantages of the present disclosure are described in further detail below with reference to the embodiments and the accompanying drawings.

### DETAILED DESCRIPTION

The technical solutions in the embodiments of the present disclosure will be clearly and completely described below in conjunction with the accompanying drawings in the embodiments of the present disclosure; it is obvious that the described embodiments are merely a part of the embodiments of the present disclosure, not all of the embodiments. All other embodiments obtained by a person of ordinary skill in the art based on the embodiments of the present disclosure without making creative efforts fall within the scope of protection of the present disclosure.

The present disclosure proposes a swimming pool cleaning robot control method; the swimming pool cleaning robot control method is applied to a swimming pool cleaning robot; the swimming pool cleaning robot is provided with a hydrophone configured for monitoring a recall signal; the hydrophone is provided at a forward movement direction of the swimming pool cleaning robot.

In some implementations, the technical solution adopted by the present disclosure primarily involves monitoring, through the hydrophone, a recall signal transmitted by a user via a signal transmitter at the poolside; the swimming pool cleaning robot travels toward a swimming pool wall according to a preset edge-approach strategy in response to the presence of the recall signal being monitored by the hydrophone. The recall signal may be, for example, a linear frequency modulation, LFM, signal or an encoded signal transmitted by the user via the signal transmitter.

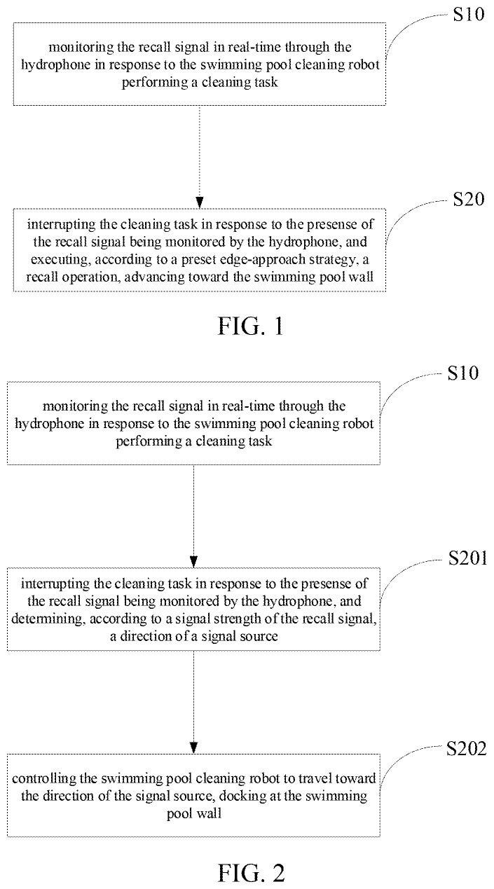

Specifically, referring to FIG. 1, a first embodiment of the swimming pool cleaning robot control method of the present disclosure includes the following steps:

Step S10: monitoring the recall signal in real-time through the hydrophone in response to the swimming pool cleaning robot executing a cleaning task.

The signal source of the recall signal may be a linear frequency modulation, LFM, signal or an encoded signal transmitted by the user via a signal transmitter at the poolside.

Step S20: interrupting the cleaning task and traveling toward the swimming pool wall according to the preset edge-approach strategy in response to the presence of the recall signal being monitored by the hydrophone.

The edge-approach strategy may be controlling the swimming pool cleaning robot to travel forward according to a current movement direction until arrival at the swimming pool wall; or determining a location direction of the signal source based on a signal strength of the recall signal, and controlling the swimming pool cleaning robot to travel toward the location direction of the signal source for docking at the swimming pool wall.

In the present embodiment, the above technical solution leads to monitoring the recall signal in real-time through the hydrophone; the swimming pool cleaning robot travels toward the swimming pool wall according to the preset edge-approach strategy in response to the presence of the recall signal being monitored by the hydrophone, thereby enabling the swimming pool cleaning robot to automatically approach the wall, improving work efficiency and user experience.

A second embodiment of the swimming pool cleaning robot control method of the present disclosure is proposed based on the first embodiment shown in FIG. 1.

Referring to FIG. 2, step S20 in the present embodiment includes:

Step S201: interrupting the cleaning task and determining a location direction of the signal source based on the signal strength of the recall signal in response to the presence of the recall signal being monitored by the hydrophone.

Specifically, the present embodiment leads to acquiring a direction of the strongest recall signal by employing multi-path effect and fading principle, interrupting the cleaning task, and acquiring the location direction of the signal source based on the direction of the strongest recall signal.

In the present embodiment, the hydrophone monitoring the recall signal is provided on the forward movement direction of the swimming pool cleaning robot; the recall signal may still be monitored even if the orientation of the swimming pool cleaning robot is not the direction of the signal source due to the existence of the multi-path effect, with the only difference being that its signal power is not as good as when the hydrophone directly faces the location direction of the signal source.

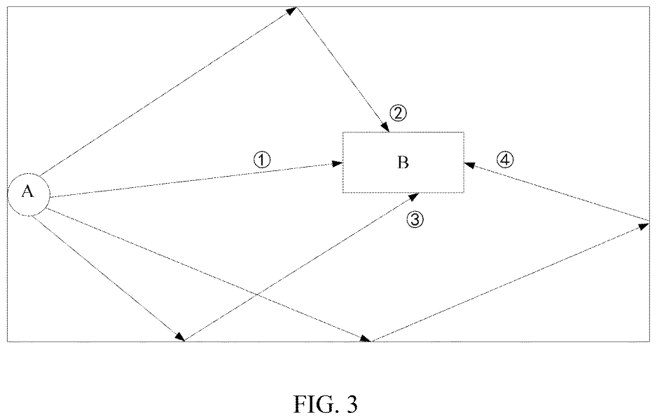

As shown in FIG. 3, A is the recall signal source, B is the swimming pool cleaning robot equipped with the hydrophone, and the signal propagation paths are schematically represented as four situations \textcircled{1}, \textcircled{2}, \textcircled{3}, and \textcircled{4} in the figure, where path \textcircled{1} has the shortest distance and path \textcircled{4} has the longest distance. According to the fading principle of multi-path propagation, the signal propagates to the swimming pool cleaning robot through path \textcircled{1} with the shortest distance and the smallest fading, retaining the most signal power, thus having the strongest signal power; when the signal propagates to the swimming pool cleaning robot through path \textcircled{4}, the signal propagation distance is the farthest and the fading is the largest, thus retaining the least power and having the weakest signal power.

Step S202: controlling the swimming pool cleaning robot to travel toward the location direction of the signal source for docking at the swimming pool wall.

The swimming pool cleaning robot is controlled to travel toward the location direction of the signal source for docking at the swimming pool wall in response to determining the location direction of the signal source. The swimming pool cleaning robot is considered to have arrived at the location of the recall signal source in response to the swimming pool cleaning robot traveling forward along the direction of the strongest signal until reaching the swimming pool wall; operation is stopped at this time, waiting to be retrieved.

The swimming pool cleaning robot continues execution of the swimming pool cleaning task or interrupts the swimming pool cleaning task during its travel toward the location direction of the signal source.

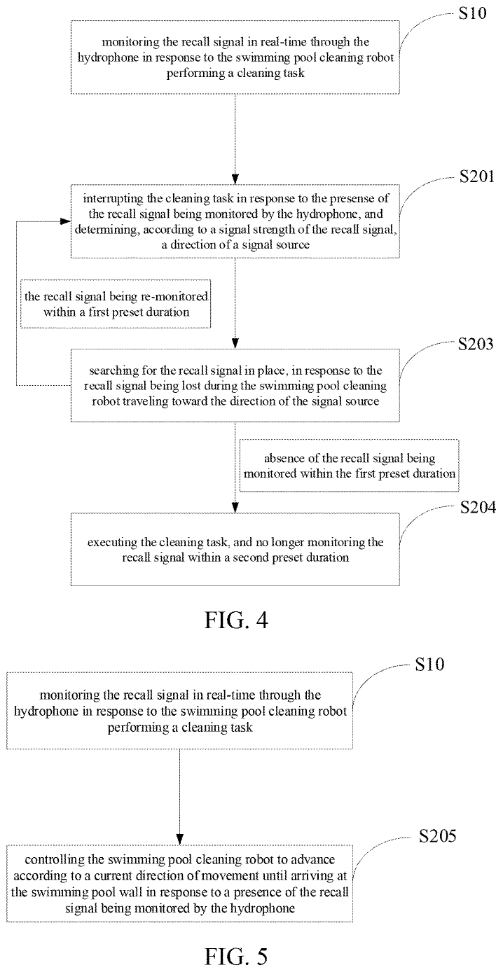

In some implementations, a third embodiment of the swimming pool cleaning robot control method of the present disclosure is proposed based on the second embodiment shown in FIG. 2; as shown in FIG. 4, step S202 in the present embodiment includes:

Step S203: searching for the recall signal in place in response to the loss of the recall signal during the travel of the swimming pool cleaning robot toward the location direction of the signal source.

It is to be understood that, in the present embodiment, the signal transmitter transmits signals to the swimming pool cleaning robot periodically, for example, transmitting the recall signal every minute; this cycle duration may be set based on practical experience. The loss of the recall signal in the present embodiment refers to the hydrophone not receiving the recall signal transmitted by the signal transmitter within this cycle or within a preset duration exceeding this cycle.

In the present embodiment, the swimming pool cleaning robot searches for the recall signal in place in response to the loss of the recall signal during its travel toward the location direction of the signal source, until the recall signal is retrieved, or the number of search failures reaches N times, or the duration of the failed search for the recall signal reaches a first preset duration, and then continues execution of the cleaning task; the first preset duration may also be set based on practical experience.

Returning to execute step s201 in response to re-monitoring the recall signal within the first preset duration.

In the present embodiment, step S201 is returned to for execution in response to the hydrophone re-monitoring the recall signal within the first preset duration, thereby determining the location direction of the signal source based on the signal strength of the recall signal.

Executing step S204, executing the cleaning task, and no longer monitoring the recall signal within a second preset duration in response to an absence of the recall signal being monitored within the first preset duration.

In the present embodiment, the cleaning task is continued in response to an absence of the recall signal being monitored by the hydrophone within the second preset duration, and the recall signal is no longer monitored within the second preset duration, thereby reducing energy consumption of the underwater robot, where the second preset duration may be set according to actual empirical values, such as 1 min, which is not limited in the present embodiment.

In some implementations, in the present embodiment, the method further includes:
the cleaning task is continued in response to an absence of the recall signal being monitored by the hydrophone.

After step S202, the following is further included:
the swimming pool cleaning robot is controlled to climb the wall and surface along the swimming pool wall in response to the swimming pool cleaning robot arriving at the swimming pool wall.

In the present embodiment, one hydrophone is employed to monitor the recall signal, the cleaning task is interrupted or not interrupted and the signal power is calculated in response to the recall signal being monitored, and the swimming pool cleaning robot is caused to dock towards the direction with the greatest signal power. According to the multi-path fading effect of signals, it is known that the signal power is the strongest when the signal propagation path between the recall signal source and the swimming pool cleaning robot is the shortest, therefore, the direction of the strongest detected signal power is often the direction where the recall signal source is located (as shown by \textcircled{1} in FIG. 3), so the swimming pool cleaning robot may arrive at the location where the recall signal source is located by traveling towards this direction. In the present embodiment, if the swimming pool cleaning robot is configured with functions such as wall climbing or surfacing, it may be made to climb the wall or surface after arriving at the target location, making it easier to be lifted.

Through the aforementioned technical solution, the present embodiment monitors the recall signal in real-time through the hydrophone; determines the direction where the signal source is located according to the signal strength of the recall signal in response to the presence of the recall signal being monitored by the hydrophone; and controls the swimming pool cleaning robot to travel towards the direction where the signal source is located and dock towards the swimming pool wall, enabling the swimming pool cleaning robot to immediately find the nearest swimming pool wall for automatic edge approach according to the strength of the recall signal, leading to improved work efficiency and user experience.

Based on the first embodiment shown in FIG. 1, a fourth embodiment of the swimming pool cleaning robot control method of the present disclosure is proposed.

As shown in FIG. 5, in the present embodiment, in the swimming pool cleaning robot control method, step S20 includes:

Step S205: controlling the swimming pool cleaning robot to advance according to a current direction of movement until arriving at the swimming pool wall in response to a presence of the recall signal being monitored by the hydrophone.

In the present embodiment, in response to the presence of the recall signal being monitored by the hydrophone, the recall signal power is not calculated according to actual needs, and the swimming pool cleaning robot is controlled to directly advance according to the current direction of movement until arriving at the swimming pool wall, enabling the swimming pool cleaning robot to automatically approach the edge.

The beneficial effects of the swimming pool cleaning robot control method of the present disclosure are as follows:

Through the aforementioned technical solution, the present disclosure monitors the recall signal in real-time through the hydrophone; and executes a recall operation according to a preset edge-approach strategy and advances towards the swimming pool wall in response to the presence of the recall signal being monitored by the hydrophone, enabling the swimming pool cleaning robot to automatically approach the edge, leading to improved work efficiency and user experience.

To achieve the above objective, the present disclosure also proposes a swimming pool cleaning robot control system, where the swimming pool cleaning robot is provided with a hydrophone configured to monitor a recall signal, and the system includes a memory, a processor, and a swimming pool cleaning robot control program stored on the processor, where the swimming pool cleaning robot control program, when executed by the processor, performs the following steps:
monitoring the recall signal in real-time through the hydrophone when the swimming pool cleaning robot executes a cleaning task;
interrupting the cleaning task and advancing towards the swimming pool wall according to a preset edge-approach strategy in response to the presence of the recall signal being monitored by the hydrophone.

The swimming pool cleaning robot control program, when executed by the processor, further performs the following steps:
interrupting the cleaning task and determining the direction where the signal source is located according to the signal strength of the recall signal in response to the presence of the recall signal being monitored by the hydrophone;
controlling the swimming pool cleaning robot to travel towards the direction where the signal source is located and dock towards the swimming pool wall.

The beneficial effects of the swimming pool cleaning robot control system of the present disclosure are as follows:

Through the aforementioned technical solution, the present disclosure monitors the recall signal in real-time through the hydrophone; and executes a recall operation according to a preset edge-approach strategy and advances towards the swimming pool wall in response to the presence of the recall signal being monitored by the hydrophone, enabling the swimming pool cleaning robot to automatically approach the edge, leading to improved work efficiency and user experience.

To achieve the above objective, the present disclosure also proposes a non-transitory computer-readable storage medium, where the non-transitory computer-readable storage medium stores a swimming pool cleaning robot control program, and the swimming pool cleaning robot control program, when executed by a processor, performs the steps of the method as described above, which are not repeated here.

The above descriptions are merely preferred embodiments of the present disclosure, and do not limit the patent scope of the present disclosure; all equivalent structural transformations made under the concept of the present disclosure using the content of the specification and drawings of the present disclosure, or direct/indirect applications in other related technical fields are included within the patent protection scope of the present disclosure.

What is claimed is:

1. A swimming pool cleaning robot control method, wherein the swimming pool cleaning robot control method is applied to a swimming pool cleaning robot, the swimming pool cleaning robot is provided with a hydrophone for monitoring a recall signal, the swimming pool cleaning robot control method comprising the following steps:
step S10, monitoring the recall signal in real-time through the hydrophone in response to the swimming pool cleaning robot performing a cleaning task;
step S20, interrupting the cleaning task in response to a presence of the recall signal being monitored by the hydrophone, and executing, according to a preset edge-approach strategy, a recall operation, advancing toward a swimming pool wall.

2. The swimming pool cleaning robot control method according to claim 1, wherein step S20 further comprises:
step S201, interrupting the cleaning task in response to the presence of the recall signal being monitored by the hydrophone, and determining, according to a signal strength of the recall signal, a direction of a signal source;
step S202, controlling the swimming pool cleaning robot to travel toward a direction of the signal source, docking at the swimming pool wall.

3. The swimming pool cleaning robot control method according to claim 2, wherein step S201 comprises:
acquiring, using a multi-path effect and a fading principle, a direction with a strongest recall signal, interrupting the cleaning task, and acquiring, according to the direction with the strongest recall signal, the direction of the signal source.

4. The swimming pool cleaning robot control method according to claim 3, wherein step S202 comprises:
step S203, searching for the recall signal in place in response to the recall signal being lost during the swimming pool cleaning robot traveling toward the direction of the signal source;
returning to execute step S201 in response to the recall signal being re-monitored within a first preset duration;
executing step S204, executing the cleaning task, and no longer monitoring the recall signal within a second preset duration in response to an absence of the recall signal being monitored within the first preset duration.

5. The swimming pool cleaning robot control method according to claim 4, wherein the method further comprises:
step S101, continuing to execute the cleaning task in response to the absence of the recall signal being monitored by the hydrophone.

6. The swimming pool cleaning robot control method according to claim 1, wherein after step S202, the method comprises:
controlling the swimming pool cleaning robot to climb the wall along the swimming pool wall and surface in response to the swimming pool cleaning robot arriving at the swimming pool wall.

7. The swimming pool cleaning robot control method according to claim 1, wherein step S20 comprises:
step S205, controlling the swimming pool cleaning robot to advance according to a current movement direction until arriving at the swimming pool wall in response to the presence of the recall signal being monitored by the hydrophone.

8. A swimming pool cleaning robot control system, wherein a swimming pool cleaning robot is provided with a hydrophone for monitoring a recall signal, the system comprises a memory, a processor, and a swimming pool cleaning robot control program stored on the processor, the swimming pool cleaning robot control program, when invoked by the processor, executing the following steps:
monitoring the recall signal in real-time through the hydrophone in response to the swimming pool cleaning robot performing a cleaning task;
interrupting the cleaning task in response to a presence of the recall signal being monitored by the hydrophone, and advancing, according to a preset edge-approach strategy, toward a swimming pool wall.

9. The swimming pool cleaning robot control system according to claim 8, wherein the swimming pool cleaning robot control program, when invoked by the processor, further executing the following steps:
interrupting the cleaning task in response to the presence of the recall signal being monitored by the hydrophone, and determining, according to a signal strength of the recall signal, a direction of a signal source;
controlling the swimming pool cleaning robot to travel toward the direction of the signal source, docking at the swimming pool wall.

10. A non-transitory computer-readable storage medium, wherein the non-transitory computer-readable storage medium stores a swimming pool cleaning robot control program, the swimming pool cleaning robot control program, when executed by a processor, executing the following steps:
step S10, monitoring a recall signal in real-time through a hydrophone in response to the swimming pool cleaning robot performing a cleaning task;
step S20, interrupting the cleaning task in response to a presence of the recall signal being monitored by the hydrophone, and executing, according to a preset edge-approach strategy, a recall operation, advancing toward a swimming pool wall;
the step S20 comprises:
step S201, interrupting the cleaning task in response to the presence of the recall signal being monitored by the hydrophone, and determining, according to a signal strength of the recall signal, a direction of a signal source;
step S202, controlling the swimming pool cleaning robot to travel toward the direction of the signal source, docking at the swimming pool wall;
the step S201 specifically comprises:
acquiring, using a multi-path effect and a fading principle, a direction with a strongest recall signal, interrupting the cleaning task, and acquiring, according to the direction with the strongest recall signal, the direction of the signal source;
the step S202 comprises:
step S203, searching for the recall signal in place in response to the recall signal being lost during the swimming pool cleaning robot traveling toward the direction of the signal source;
returning to execute step S201 in response to the recall signal being re-monitored within a first preset duration;
executing step S204, executing the cleaning task, and no longer monitoring the recall signal within a second preset duration in response to an absence of the recall signal being monitored within the first preset duration.
